(19) United States
(12) Patent Application Publication
(10) Pub. No.: US 2014/0267907 A1
(43) Pub. Date: Sep. 18, 2014

(54) MULTIMEDIA PRESENTATION TRACKING IN NETWORKED ENVIRONMENT

(71) Applicant: Verance Corporation, San Diego, CA (US)

(72) Inventors: Patrick George Downes, San Diego, CA (US); Rade Petrovic, San Diego, CA (US)

(73) Assignee: VERANCE CORPORATION, San Diego, CA (US)

(21) Appl. No.: 14/209,486

(22) Filed: Mar. 13, 2014

Related U.S. Application Data
(60) Provisional application No. 61/780,088, filed on Mar. 13, 2013.

(51) Int. Cl. H04N 5/08

(52) U.S. Cl. CPC H04N 5/08
USPC 348/525

(57) ABSTRACT

Methods, devices, systems and computer programs facilitate presentation of a second content in synchronization with a first content. In one method, at least a portion of a first content that is being presented by a first device is received at a second device. The first content includes substantially imperceptible watermarks that are embedded in one or more components of the first content. A first watermark detection result is obtained by performing a watermark detection operation. Additionally, a second watermark detection result associated with the first content is received at the second device from a device other than the second device. The first watermark detection result and the second watermark detection result are augmented to obtain a combined watermark detection result, and the combined detection result is used to enable presentation of a second content in synchronization with the first content.

### CROSS REFERENCE TO RELATED APPLICATIONS

This patent application claims the benefit of U.S. Provisional Patent Application No. 61/780,088, filed Mar. 13, 2013. The entire content of the before-mentioned provisional patent application is incorporated by reference as part of the disclosure of this application.

### FIELD OF INVENTION

The present application relates to multimedia presentation and in particular to methods, devices, systems and computer program products that facilitate tracking of multimedia content and presentation of additional content.

### BACKGROUND

The use and presentation of multimedia content on a variety of mobile and fixed platforms have rapidly proliferated. By taking advantage of storage paradigms, such as cloud-based storage infrastructures, reduced form factor of media players, and high-speed wireless network capabilities, users can readily access and consume multimedia content regardless of the physical location of the users or the multimedia content. A multimedia content, such as an audiovisual content, often consists of a series of related images which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc. In some scenarios, such a multimedia content, or portions thereof, may contain only one type of content, including, but not limited to a still image, a video sequence and an audio clip, while in other scenarios, the multimedia content, or portions thereof may contain two or more types of content.

### SUMMARY OF SELECTED EMBODIMENTS

The disclosed embodiments facilitate the presentation of a second content in synchronization with a first content and further relate to tracking the timeline of the content presentation. One aspect of the present application related to a method that includes receiving, at a second device, where at least a portion of a first content is being presented by a first device, and the first content includes substantially imperceptible watermarks that are embedded in one or more components of the first content. The method further includes performing watermark detection operations to obtain a first watermark detection result, receiving, at the second device, a second watermark detection result associated with the first content from a device other than the second device, and augmenting the first watermark detection result and the second watermark detection result to obtain a combined watermark detection result. The method additionally includes using the combined detection result to enable presentation of a second content in synchronization with the first content.

In one exemplary embodiment, using the combined detection result improves synchronization of the presentation of the second content with respect to the first content compared to a synchronization that would be achieved using the first detection result alone or the second detection result alone. In another exemplary embodiment, the second detection result enables presentation of the second content in synchronization with the first content when at least apart of the first detection result is missing or is unreliable. In yet another exemplary embodiment, the second watermark detection result is communicated to the second device using anon-acoustical communication channel. In such an exemplary embodiment, the non-acoustical communication channel can use one of a or Bluetooth technologies.

According to another exemplary embodiment, the second watermark detection result is obtained from processing one or more components of the first content that is obtained using one or more of the following channels: an acoustical channel, an non-acoustical channel, an optical channel, or a non-optical channel. In another embodiment, the above method further includes receiving, at the second device, a third watermark detection result, and augmenting the first watermark detection result, with the second and the third watermark detection results to obtain the combined watermark detection result.

In still another exemplary embodiment, augmenting the first watermark detection result and the second watermark detection result comprises one or more of: (1) averaging the first watermark detection result and the second watermark detection result on a symbol-by-symbol basis, (2) averaging the first watermark detection result and the second watermark detection result on a symbol-by-symbol basis based on weights assigned to each symbol, (3) averaging the first watermark detection result and the second watermark detection result on a packet-by-packet basis, or (4) averaging the first watermark detection result and the second watermark detection result on a packet-by-packet basis based on weights assigned to each packet.

In one exemplary embodiment, the method further includes communicating one or more of the first, the second or the combined watermark detection results to a device other than the second device. In yet another exemplary embodiment, the embedded watermarks are multimedia presentation tracking (MPT) watermarks that include information that enables one or more of the following: identification of the first content, tracking a timeline of the first content, identification of one or more distribution channels of the first content, identification of a television channel that the first content is presented on, determination of a time of broadcast of the first content, presentation of a foreign language edition of the first content, or identification of the second content.

Another aspect of the disclosed embodiments relates to a device that includes a watermark extractor to produce a first watermark detection result based on embedded watermarks extracted from at least a portion of a first content as the first content is being presented by a first device and a receiver coupled to a wireless communication channel to receive a second watermark detection result. The device also includes a processor configured to augment the first the first watermark detection result and the second watermark detection result to obtain a combined watermark detection result, and to enable presentation of a second content in synchronization with the first content.

In one exemplary embodiment, the receiver of the above device is configured to receive a third watermark detection result, and its processor is configured to augment the first watermark detection result, with the second and third watermark detection results to obtain the combined watermark detection result. In another exemplary embodiment, the processor is configured to augment the first watermark detection result and the second watermark detection result by one or more of: averaging the first watermark detection result and the second watermark detection result on a symbol-by-symbol basis, averaging the first watermark detection result and the second watermark detection result on a symbol-by-symbol basis based on weights assigned to each symbol, averaging the first watermark detection result and the second watermark detection result on a packet-by-packet basis, or averaging the first watermark detection result and the second watermark detection result on a packet-by-packet basis based on weights assigned to each packet. In one exemplary embodiment, the device also includes a transmitter coupled to a communication module to communicate one or more of the first, second or combined watermark detection results to a different device.

Another aspect of the disclosed embodiments relates to a device that includes a processor, and a memory comprising processor executable code. The processor executable code, when executed by the processor, configures the device to receive at least a portion of a first content being presented by a first device, where the first content includes substantially imperceptible watermarks that are embedded in one or more components of the first content. The processor executable code, when executed by the processor, further configures the device to perform watermark detection operations to obtain a first watermark detection result, receive a second watermark detection result associated with the first content from a device other than the second device, augment the first watermark detection result and the second watermark detection result to obtain a combined watermark detection result, and use the combined detection result to enable presentation of a second content in synchronization with the first content.

Another aspect of the disclosed embodiments relates to a computer program product, embodied on one or more non-transitory computer readable media, comprising program code for receiving at least a portion of a first content being presented by a first device, where the first content includes substantially imperceptible watermarks that are embedded in one or more components of the first content. The computer program product further includes program code for receiving performing watermark detection operations to obtain a first watermark detection result, program code for receiving a second watermark detection result associated with the first content from a device other than the second device, program code for augmenting the first watermark detection result and the second watermark detection result to obtain a combined watermark detection result, and program code for using the combined detection result to enable presentation of a second content in synchronization with the first content.

Another aspect of the disclosed embodiments relates to a system that includes a first device coupled to one or both of a display screen or a speaker to present a first content, where the first content includes substantially imperceptible watermarks that are embedded in one or more components of the first content. The system also includes a second device that includes one or more of a communication module, a microphone, a camera, an audio input or a video input to receive at least a portion of the first content as the first content is being presented by the first device. The second device also includes a watermark extractor component to perform watermark detection operations to obtain a first watermark detection result from the received portion or portions of the first content. One or more of the communication module, the microphone, the camera, the audio input or the video input further enable the second device to receive a second watermark detection result associated with the first content from a device other than the second device. The second device also includes a processor coupled to one or more of the communication module, the microphone, the camera, the audio input, the video input, or the watermark extractor component to augment the first watermark detection result and the second watermark detection result to obtain a combined watermark detection result, and to use the combined detection result to enable presentation of a second content in synchronization with the first content.

In one exemplary embodiment, the above system further includes a database that is coupled to at least one of the first device or the second device. In one embodiment, the second device is configured to receive the second watermark detection results from the database. In another exemplary embodiment, the system further includes at least a third device that is coupled to the second device through a communication channel and the third device is configured to produce the second watermark detection result and to communicate the second watermark detection result to the second device. In yet another exemplary embodiment, the second watermark detection result is obtained from processing one or more components of the first content that is obtained using one or more of the following channels: an acoustical channel, an non-acoustical channel, an optical channel, or a non-optical channel.

Another aspect of the disclosed embodiments relates to a method for enhancing synchronized presentation of a second content with respect to a first content. The method includes producing a first watermark detection result based on processing a particular segment of the first content that is received from one of: an optical channel or an acoustical channel. The method also includes receiving a second watermark result through a wireless communication channel that is not an optical or an acoustical channel, where the second watermark detection result corresponds to the particular segment of the first content. The method additionally includes augmenting the first watermark detection result and the second watermark detection result to obtain a combined watermark detection result, and using the combined detection result to enable presentation of the second content in synchronization with the first content.

Another aspect of the disclosed embodiments relates to a computer program product, embodied on one or more non-transitory computer readable media. The computer program product includes program code for producing a first watermark detection result based on processing a particular segment of the first content that is received from one of: an optical channel or an acoustical channel. The computer program product also includes program code for receiving a second watermark result through a wireless communication channel that is not an optical or an acoustical channel, where the second watermark detection result corresponds to the particular segment of the first content. The computer program product additionally includes program code for augmenting the first watermark detection result and the second watermark detection result to obtain a combined watermark detection result, and program code for using the combined detection result to enable presentation of the second content in synchronization with the first content.

Another aspect of the disclosed embodiments relates to a device that includes a processor, and a memory comprising processor executable code. The processor executable code, when executed by the processor, configures the device to produce a first watermark detection result based on processing a particular segment of the first content that is received from one of: an optical channel or an acoustical channel. The processor executable code, when executed by the processor, further configures the device to receive a second watermark result through a wireless communication channel that is not an optical or an acoustical channel, the second watermark detection result corresponding to the particular segment of the first content, augment the first watermark detection result and the second watermark detection result to obtain a combined watermark detection result, and use the combined detection result to enable presentation of the second content in synchronization with the first content.

Another aspect of the disclosed embodiments relates to a method that includes receiving, at a second device from a first device, a first portion of a first content, receiving, at the second device from a third device, the first portion of the first content, combining, at the second device, the first portion of the first content received from the first device and the first portion of the first content received from the third device to obtain a combined content, processing, at the second device, the combined content to obtain a multimedia presentation tracking information, and using the multimedia presentation tracking information to enable presentation of a second content in synchronization with the first content.

Another aspect of the disclosed embodiments relates to a computer program product, embodied on one or more non-transitory computer readable media. The computer program product includes program code for receiving, at a second device from a first device, a first portion of a first content, program code for receiving, at the second device from a third device, the first portion of the first content, and program code for combining, at the second device, the first portion of the first content received from the first device and the first portion of the first content received from the third device to obtain a combined content. The computer program product additionally includes
program code for processing, at the second device, the combined content to obtain a multimedia presentation tracking information, and program code for using the multimedia presentation tracking information to enable presentation of a second content in synchronization with the first content.

Another aspect of the disclosed embodiments relates to a device, that includes a processor, and a memory comprising processor executable code. The processor executable code, when executed by the processor, configures the device to receive, from a first device, a first portion of a first content, to receive, from a third device, the first portion of the first content and to combine the first portion of the first content received from the first device and the first portion of the first content received from the third device to obtain a combined content. The processor executable code, when executed by the processor, further configures the device to process the combined content to obtain a multimedia presentation tracking information, and to use the multimedia presentation tracking information to enable presentation of a second content in synchronization with the first content.

Another aspect of the disclosed embodiments relates to a method that includes receiving, at a second device equipped with a multimedia presentation tracking detector, information indicative of a multimedia presentation tracking information obtained from a first content being presented by a first device. The information includes a source identifier identifying a first source used for obtaining the multimedia presentation tracking information. The method also includes determining a first reliability of the received multimedia presentation tracking information based on at least the source identifier, comparing the first reliability to a second reliability associated with the multimedia presentation tracking watermark detector, and upon a determination that the first reliability exceeds the second reliability, selecting the received multimedia presentation tracking information to enable presentation of a second content in synchronization with the first content.

Another aspect of the disclosed embodiments relates to a computer program product that is embodied on one or more non-transitory computer readable media. The computer program product includes program code for receiving, at a second device equipped with a multimedia presentation tracking detector, information indicative of a multimedia presentation tracking information obtained from a first content being presented by a first device, where the information includes a source identifier identifying a first source used for obtaining the multimedia presentation tracking information. The computer program product also includes program code for determining a first reliability of the received multimedia presentation tracking information based on at least the source identifier, program code for comparing the first reliability to a second reliability associated with the multimedia presentation tracking watermark detector, and program code for, upon a determination that the first reliability exceeds the second reliability, selecting the received multimedia presentation tracking information to enable presentation of a second content in synchronization with the first content.

Another aspect of the disclosed embodiments relates to a method that includes receiving, at a second device, at least a first portion of a first content being presented by a first device, processing the at least the first portion of the first content to obtain a first multimedia presentation tracking information, and receiving, at the second device, a second multimedia presentation tracking information associated with the first content from a device other than the second device. The method also includes augmenting the first multimedia presentation tracking information and the second multimedia presentation tracking information to obtain a combined multimedia presentation tracking information, and using the combined multimedia presentation tracking information to enable presentation of a second content in synchronization with the first content.

### BRIEF DESCRIPTION OF THE DRAWINGS

FIG. 1 illustrates a system that can accommodate the disclosed embodiments.

FIG. 2 illustrates a block diagram of a device within which certain disclosed embodiments may be implemented.

FIG. 3 illustrates a set of exemplary operations that can be carried out to enhance presentation of a second content in synchronization with a first content in accordance with an exemplary embodiment.

FIG. 4 illustrates a block diagram of a device within which various disclosed embodiments may be implemented.

FIG. 5 illustrates a set of exemplary operations that can enhance presentation of a second content in synchronization with a first content in accordance with another exemplary embodiment.

FIG. 6 illustrates a set of exemplary operations that can enhance presentation of a second content in synchronization with a first content in accordance with another exemplary embodiment.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Multimedia content can be identified using a variety of techniques. For example, a portion of the multimedia file (e.g., a file header) can be used to carry identification information such as the name and the size of the multimedia content, the date at which the content was produced or edited, the owner of the content and the like. While such identification techniques may be useful in some applications, they requires the presence of additional data that must be interleaved, prepended or appended to a multimedia content, which occupies additional bandwidth and, more importantly, can be lost when content is transformed into a different format (such as digital to analog conversion, transcoded into a different file format, etc.). Therefore alternative techniques for content identification can complement metadata multiplexing technique.

In the case of time varying content, such as audiovisual content, it is often desirable to track the timeline of the content presentation with the objective to provide users with additional information that is relevant in view of current content presentation. Furthermore, in some cases it is desirable to identify the distribution channel(s) for a particular content, such as optical disk distribution, web streaming service, TV broadcast etc. Depending on the distribution channel, different sets of additional information may be provided to users. Both the timeline of presentation and the distribution channel could be delivered with the content metadata, but again, it is often desirable to provide additional techniques to deliver this information in the case that it is lost at the moment of presentation.

Multimedia Presentation Tracking (MPT) may comprise content identification, content timeline tracking, distribution channel identification, or combination of those. In some cases, the objective is to identify a particular TV channel that the content is presented on, and the time of the broadcast (which in turn can be used to identify the content itself), while in other cases, it is desirable to identify a foreign language edition of content released on an optical disk.

Most common alternate methods for MPT are watermarking and fingerprinting techniques. Using watermarking techniques, an imperceptible auxiliary signal is embedded into the multimedia content that can carry identification information associated with the content, content timeline information as well as distribution channel information. In fingerprinting techniques, inherent features of the content are analyzed (as opposed to the insertion of a foreign signal that is done in watermarking techniques) to produce a mathematical signature or fingerprint from those inherent features that uniquely identify the content, as well as its timeline.

In some exemplary embodiments, the content (i.e., the primary media content or the first content) that is presented by the first device is encoded with auxiliary information that allows identification of the presented content. For example, the auxiliary information can be substantially imperceptibly embedded into a component of the first content (e.g., in the audio track and/or video frames of the content) using any one of the watermark embedding techniques that is known in the art. The embedded watermarks are typically not perceivable by humans but can be detected by a watermark extractor that is implemented as part of a watermark detection device. For example, at least a portion of the audio track of the primary content is captured by a user device (e.g., through a microphone) and processed to determine if it includes embedded auxiliary information. Upon detection of the auxiliary information that represents MPT information, the user device can present a second content on a second device. The second content can be any content that enhances viewing of, or is related to the content or the user of the content. For example, the second content can be an advertisement, an alternate ending of the content, messages from other users, and the like.

FIG. 1 illustrates a system 100 that can accommodate the disclosed embodiments. The system 100 includes a first device 102 that is configured to present a multimedia content. The content can be an entertainment content, such as a movie or a TV show, a live broadcast, and the like. The first device 102 can be coupled to, or include, a display screen, a projector screen, one or more speakers and the associated circuitry and/or software components to enable the reception, processing and presentation of a multimedia content. The first device 102 may also be in communication with a storage 104 unit. The storage 104 unit can be any one of, or a combination of, a local and a remote (e.g., cloud-based) storage device. The storage 104 unit can store a variety of multimedia content, meta data, applications, instructions, etc., which may be stored on magnetic, optical, semiconductor and/or other types of memory devices. The first device 102 may, alternatively or additionally, be configured to receive multimedia content and metadata through one or more other sources 116, such as through the Internet, through a terrestrial broadcast channel, through a cable network, through a home network (e.g., a Digital Living Network Alliance (DLNA) compliant network), through a wired or wireless network (e.g. a local area network (LAN), wireless LAN (WLAN), a wide area network (WAN) and the like). Such a media content can also be a real-time (e.g., streaming) content that is broadcast, unicast or otherwise provided to the first device 102. The received content can be at least partially stored and/or buffered before being presented by the first device 102.

Referring again to FIG. 1, at least a portion of the first (or primary) media content that is presented by the first device 102 is received by at least one device, such as the second device 106. At least a portion of the first media content that is presented by the first device 102 may be received by devices other than the second device 106, such as the third device 108, fourth device 110, fifth device 112, etc. The terms “secondary device” or “secondary devices” are sometimes used to refer to one or more of the second device 106, third device 108, fourth device 110, fifth device 112, etc. In some embodiments, additional systems similar to the system 100 of FIG. 1 can simultaneously access and present the same content. For example, the system 100 of FIG. 1 can reside at a first household white a similar system can reside at a second household, both accessing the same content (or different contents) and presenting them to a plurality of devices or users of the devices.

One or more of the second 106, the third 108, the fourth 110, the fifth 112, etc., devices can be in communication with a database 114. The database 114 includes one or more storage 118 devices for storage of a variety of multimedia content, meta data, survey results, applications, instructions, etc., which may be stored on magnetic, optical, semiconductor and/or other types of memory devices. The content that is stored at database 114 can include one or more versions of a second content that is tailored to accommodate needs of users of the secondary devices 106, 108, 110 and 112 to, for example, allow full comprehension of the first content as is being presented by the first device 102. Such second content is sometimes referred to as the “second screen content” or “second content.” It is, however, understood that such a content can be in one or more of a variety of content formats, such as in an audio format, video format, text, Braille content, and the like. The database 114 can include a remote (e.g., cloud-based) storage device. The database 114 can further include, or be in communication with, one or more processing devices 120, such as a computer, that is capable of receiving and/or retrieving information, data and commands, processing the information, data, commands and/or other information, and providing a variety of information, data, commands. In some embodiments, the one or more processing devices 120 are in communication with the one or more of the secondary devices and can, for example, send/receive data, information and commands to/from the secondary devices. While the different secondary devices can indirectly communicate with one another through the database 114, in some embodiments, a particular secondary device (such as the second device 106) may be directly in communication with another secondary device (such as the third device 108), without having to go through the database 114.

In one specific example, the first device 102 is a television set that is configured to present a video content and an associated audio content, and at least one of the secondary devices is a portable media device (e.g., a smart phone, a tablet computer, a laptop, etc.) that is equipped to receive the audio portions of the presented content through a an interface, such as a microphone input. In this specific example, each of the secondary devices can be further configured to process the captured audio content, process the audio content to detect MPT information, such as an identification information, synchronization and timing information, and the like, and to further present a second content to the user. In some embodiments, a particular secondary device can transmit/receive the result of audio or video processing to/from another secondary device.

In another example, the first device 102 can be any audio-visual presentation device that, for example, includes a display. In some example, the first device 102 also includes a media center, a receiver and other components that allow presentation and management of various stored, incoming and outgoing contents. In some exemplary scenarios, one or more of the secondary devices are configured to receive at least a portion of the content presented by the first device 102: (a) by capturing at least a portion of the presented video, (b) by capturing at least a portion of presented audio (c) through wireless transmissions (e.g., 802.11 protocol, Infrared transmissions, etc.) from the first device 102, and/or (d) through wired transmissions that are provided by the first device 102. These various transmission channels and mechanisms for conveying one or more components of the content (or information such as time codes associated with the content) to the secondary devices are shown in FIG. 1 as arrows that originate from the first device 102 in the direction of the second 106, the third 108, the fourth 110, the fifth 112, etc., devices.

FIG. 2 illustrates a block diagram of a device 200 within which certain disclosed embodiments may be implemented. The exemplary device 200 of FIG. 2 may be integrated into as part of the first device 102 and/or the second 106, the third 108, the fourth 110 and the fifth 112 devices that are illustrated in FIG. 1. The device 200 comprises at least one processor 204 and/or controller, at least one memory 202 unit that is in communication with the processor 204, and at least one communication unit 206 that enables the exchange of data and information, directly or indirectly, through the communication link 208 with other entities, devices, databases and networks (collectively illustrated in FIG. 2 as Other Entities 216). The communication unit 206 may provide wired and/or wireless communication capabilities in accordance with one or more communication protocols and, therefore, it may comprise the proper transmitter/receiver antennas, circuitry and ports, as well as the encoding/decoding capabilities that may be necessary for proper transmission and/or reception of data and other information. In some embodiments, the device 200 can also include a microphone 218 that is configured to receive an input audio signal. In some embodiments, the device 200 can also include a camera 220 that is configured to receive a video and/or still image signal. The received audio, video and/or still image signals can be processed (e.g., converted from analog to digital, color correction, sub-sampled, evaluated to detect embedded watermarks, analyzed to obtain fingerprints etc.) under the control of the processor 204. In some embodiments, instead of, or in addition to, a built-in microphone 218 and camera 220, the device 200 may be equipped with an input audio port and an input/output video port that can be interfaced with an external microphone and camera, respectively.

The device 200 may also be coupled to one or more user interface devices 210, including but not limited to, a display device, a keyboard, a speaker, a mouse, a touch pad, a Braille reader and/or a haptic interface. The haptic interface, for example, can provide a tactile feedback that takes advantage of the sense of touch by applying forces, vibrations, or motions to a user. White in the exemplary diagram of FIG. 2 the user interface devices 210 are depicted as residing outside of the device 200, it is understood that, in some embodiments, one or more of the user interface devices 210 may be implemented as part of the device 200. In some embodiments, the device 200 can also include an MPT code embedder 212 and/or an MPT code detector 214 that are configured to embed MPT codes into a media content and extract an MPT code from a media content, respectively. In some embodiments, the MPT code detector 214 can include one or both of a watermark extractor 214a and a fingerprint computation component 214b. The MPT code detector 214, the watermark extractor 214a and the fingerprint computation component 214b can be separate components that are at least partially controlled by the processor 204. In some embodiments, the MPT code detector 214, the watermark extractor 214a and the fingerprint computation component 214b are implemented as computer code stored on a computer medium and can be processed by the processor 204 to configure the device 200 to perform the associated operations.

In the exemplary scenario where the audio track of a movie is embedded with watermarks, a user device (e.g., the second 106, the third 108, the fourth 110 and/or the fifth 112 devices that are illustrated in FIG. 1) includes a watermark extractor 214a (e.g., implemented as a component within the MPT code detector 214 of FIG. 2). In this exemplary scenario, at least a portion of the audio track of the primary content is captured by a user device (e.g., by the second device 106 through a microphone 218) and processed to determine if it includes embedded auxiliary information. Upon detection of the auxiliary information, the second device can be configured to present a second content to the user. Such a second content can be presented in synchronization with the primary content. FIG. 2 also shows a trigger component 222 that is configured to trigger the presentation of the second content upon identification of the first content.

It should be noted that while various components within the device 200 of FIG. 2 are shown as separate components, some of these components may be integrated or implemented within other components of device 200. For example, the trigger component 222 can be integrated into the MPT code detector 212, or implemented as code that is executed by the processor 204. It should be further noted that, while not explicitly shown to avoid clutter, various components of the device 200 in FIG. 2 are in communication with other components of the device 200.

As noted above, and illustrated in FIG. 1, in some embodiments the second screen content may be presented in synchronization on several secondary devices. In order to enhance the user experience, in some applications it may be important to provide a reasonably accurate and steady synchronization between the primary and secondary contents. However, the acoustic capture process is inherently susceptible to noise in the acoustic propagation and capture channel. For example, the listening environment can include additional audio sources (such as people talking, street noise, noise from a different audio source, etc.) that can cause interference with the detection of watermarks from the audio track of the primary content. Additionally, the acoustic signal received at a secondary device at a particular location may be subject to more acoustic interference (e.g., due to echoes, reverbs, external noise sources, etc.) than acoustic signals at other locations, leading to delays in achieving proper synchronization and/or high dropped synchronization rates.

It is often the case, however, that in any particular location (or locations) there are additional devices, other than the secondary device of interest, that are also capable of receiving the audio signals. These devices often have different audio input, processing and communication capabilities. For instance, several people may be watching the same program on different devices, such as on a main television screen, a laptop, a tablet, a desktop, and other devices with different processing powers and audio input capabilities. One such device, can include an audio receiver component that does not use an acoustic propagation channel at all, but rather receives the audio directly from decoding the cable, satellite or over the air signals. Another device can be a desktop computer that is fitted with a higher quality external microphone. Yet another device can be a mobile phone with a relatively low quality built-in microphone, and so on.

In some exemplary embodiments, the additional devices that are capable of receiving one or more components of the primary content are used to implement a receiver diversity scheme, in which candidate devices can communicate with one another. The communication can be carried out using an ad hoc network, a peer-to-peer network, through a centralized mechanism, such as through communications with database 114 or a home gateway device, or through a direct communication link between two devices, such as Bluetooth, infrared signaling, etc. These communications can allow sharing of information related to the recovered audio watermarks, which allow such information to be combined (or augmented) with each other to reduce or eliminate noise and interference, and to dramatically improve synchronization between presentation of the first and second contents on different screens.

The following illustrates an example scenario in which the disclosed embodiments can enhance second content delivery and synchronization. Let us assume that a home theater receiver has a built in a watermark detector that extracts watermarks from audio streams sent to speakers. The watermark detector that is operating in the receiver can directly recover the watermarks from the audio (e.g., obtained and decoded via receiver's audio tuners) without any acoustic capture distortion. The receiver, which is also equipped with a transmitter (e.g., a wireless communication channel, such as Bluetooth, etc.), can robustly communicate with second screen devices to provide quick and reliable MPT information delivery. While communicating MTP information itself, the receiver may also communicate the source of MPT information, i.e. the fact that watermark extractor has examined undistorted audio signal to extract embedded watermarks. In this example, the second screen device can additionally capture the acoustically propagated audio signals using its microphone, and detect watermarks from the captured audio signal, but may chose not to do so as long as the source of more reliable information is available in the networked environment. Similarly in exemplary situations where a content is presented from a Bluray Disc player, where the MPT information can be obtained from an associated metadata and broadcast to all networked devices, then this MPT source can be treated as being the most reliable, thereby allowing all other devices to abandon MPT extraction and sharing attempts, and to operate in a purely monitoring mode.

In another example scenario, several people in the same room can be watching the same program, each having his/her own secondary device. In this exemplary scenario, some or all of the secondary devices can be communicating with one another, and each secondary device can be configured to cooperate with other devices to participate in the MPT data extraction process, or to share MPT extraction results with other devices. Sharing the detection results among multiple devices allows all devices to achieve reliability and speed of MPT data acquisition of the best positioned device. For example, if the acoustic path from the main speakers to a first device is occluded or overwhelmed by a local or directional noise source, a second device with a clear acoustical path to the main speakers can extract the MPT data and provide them to the first device. Furthermore, when anew device enters the network, it may use the already extracted MPT data from other devices, and save on time and resources that would be needed to perform the extraction on its own.

In another exemplary embodiment, the devices may cooperate to jointly achieve MPT data extraction. For example all devices can share audio data collected through their microphones. One or more of the devices can use various techniques of combining those audio signals to achieve optimum MTP data extraction. The techniques strive to achieve, for example, the best signal-to-noise ratio. In one exemplary embodiment, only one device is configured to perform the processing of different audio signals. For example, a server that has no battery power limitations can process the audio signals received from various devices, and then share the results of processing with all cooperating devices.

In some embodiments, in order to reduce the communication bandwidth, the devices may share intermediate processing results, instead of raw audio signals. For example, cooperating devices may share extracted fingerprints, which then can be combined in one more devices to obtain the most likely fingerprint estimate. Alternatively, devices may extract watermark features, which can then be shared and combined to extract the MPT data. In one exemplary embodiment, where autocorrelation modulation watermarking technology is used for embedding watermarks, each secondary device can calculate the autocorrelation function and share it with other networked devices. One or more of such networked devices can combine the autocorrelation functions to enable a reliable MPT data extraction. The basic principles of autocorrelation modulation watermarking is described in U.S. Pat. No. 5,940,135, which is herein incorporated by reference in its entirety.

The disclosed embodiments capitalize on one of the main strengths of using audio signals for MPT data extraction. That is, auxiliary information, which can be used for identification of information and other purposes, is carried in the audio content and does not rely on any other side chain information or metadata that would not survive time/place shifting or require special broadcast/distribution infrastructure. At the same time, it also ameliorates one of the weaknesses of using audio signals, which is the unpredictable nature of acoustic communication channels. Using the multiple receiver scheme of the disclosed embodiments, unreliable or missed MTP detections can be supplemented or replaced with more reliable results that are communicated through a local wireless channel. Such wireless communication channels (e.g., WiFi, Bluetooth, etc.) are often supported by typical second screen devices, such as tablets and smart phones.

The following examples illustrate how the watermark detection results can be combined using the receiver diversity systems of the disclosed embodiments. To this end, it is instructive to first describe a typical format of embedded watermarks. A watermark is typically comprised of a series of symbols (e.g., bits, bytes, etc.) that form a watermark packet. The watermark packet is then optionally appended with redundancy or parity symbols (e.g., symbols of an error correction code (ECC) or CRC code) and optionally scrambled (e.g., by performing an exclusive OR operation with a random sequence on a symbol-by-symbol basis) before being embedded into a host content. Sometimes, the packet symbols are further interleaved before embedding into the host content. For a watermark packet that undergoes the above packet formation operations, N data symbols are typically appended with K-N parity symbols to form a K-symbol packet. Such a K-symbol packet is often embedded several times in the host content to provide further redundancy.

In some exemplary embodiments, combining the watermark detection results from multiple receivers can be effectuated by simply averaging the detection results on, for example, a watermark symbol-by-symbol basis. In one example, each of the K symbols of a watermark packet are obtained from two or more devices that have watermark detection capabilities. The received symbols are averaged on a symbol-by-symbol basis to form a composite watermark packet. The composite watermark packet is then decoded using typical packet decoding operations than can include de-interleaving, ECC decoding, and the like.

In another example, instead of simple averaging, a weighted averaging technique is utilized, where each symbol is multiplied by a reliability factor (or a weight factor) before being averaged. For example, a particular receiver device may be aware of random or correlated noise and interference issues and can, accordingly, assign a corresponding weight factor for all or some of its recovered watermark symbols. In yet another example, a particular receiver may be able to obtain soft decoding information that is indicative of the reliability of symbol detection. Such soft decoding information can be obtained by, for example, performing an ECC decoding operation that can identify unreliable symbols, or through other soft decoding techniques. One exemplary technique for producing soft detection results is described in the U.S. Pat. No. 7,616,776, which is herein incorporated by reference in its entirety.

In another example, multiple detected watermark packets, rather than the watermark symbols, are combined to allow improved recovery of watermark packets. For example, each recovered watermark packet can be assigned a reliability (or weight factor), which can be obtained by, for example, comparing the K (or N) watermark symbols to a predefined template, and/or through ECC decoding. This way, a plurality of weighted watermark packets can be combined to cumulatively detect a given watermark packet that is embedded in a content. One exemplary technique of cumulative packet decoding uses a particular weight accumulation algorithm (WAA) that is described in the U.S. Pat. No. 7,616,776, which is herein incorporated by reference in its entirety.

The combination, or more generally, augmentation of the detected watermarks can be performed at one or more locations, such as at a particular first content device, at a particular second content device, at another device such as a remote database that is in communication with one or more of the first and second content devices, and combinations thereof. Each device may conduct watermark detection based on the received acoustic signal alone, based on information received from a non-acoustic channel, and based on both the acoustic signal and the information received from a non-acoustic channel, and/or based on other channels such as optical channels. Moreover, each device may make available to other devices its watermark detection results addition to additional information. Such additional information can, for example, include the identity of the device that produced the detection results, a measure of reliability of watermark detection, the type and/or identity of source(s) that provided the content that was subject to watermark detection, and the like. This additional information may be used to identify the sources and reliability of detections, and to determine whether or not to use, not use or assign a particular importance (or reliability measure) to the received detection results. It should be noted that each device may produce watermark detection results based on one more sources, and then provide the results to another device. Further, the detection results and the associated additional information may be pushed to other devices, or may be pulled by other devices, depending on the capabilities and settings of each device, and system implementation details.

It should be further noted that while the in the above examples acoustical and non-acoustical communication channels were described to facilitate the understanding of the disclosed concepts, the principles of the disclosed embodiments are also applicable in cases where the second device uses a camera to capture a video or image portion of the first content to enable presentation of the second content. In particular, in these scenarios, the second device may normally use the optically captured video or images of the first content to extract watermarks that are embedded therein. However, due to various noise and interference sources (such as movement of the capturing device, obstruction of the optical path, etc.), watermark detection results may not provide the needed synchronization accuracy. However, in accordance with the disclosed embodiments, the second device can augment, and improve, its detection results by receiving additional detection results from other devices. These additional detection results can be obtained from processing non-optical channels. Examples of non-optical channels or sources include, but are not limited to, the digital video/image of the first content itself (e.g., at a receiver of the first device), the non-acoustical audio signal (e.g., at a receiver of the first device), the acoustical audio signal that is received at another device, and combinations thereof. Moreover, the additional detection results may also be obtained from another device which has a more reliable optical capture environment (e.g., a device with a high-end camera).

FIG. 3 illustrates a set of exemplary operations that can be carried out to enhance presentation of a second content in synchronization with a first content in accordance with an exemplary embodiment. At 302, at least a portion of a first content being presented by a first device is received at a second device, where the first content includes substantially imperceptible watermarks that are embedded in one or more components of the first content. At 304 watermark detection operations are performed to obtain a first watermark detection result. At 306, a second watermark detection result associated with the first content is received at the second device from a device other than the second device. At 308, the first watermark detection result is augmented with the second watermark detection result to obtain a combined watermark detection result. At 310, the combined detection result is used to enable presentation of a second content in synchronization with the first content.

Certain aspects of the disclosed embodiments can be implemented as a device that includes a processor, and a memory comprising processor executable code. The processor executable code, when executed by the processor, configures the device to perform any one of and/or all operations that are described in the present application. For example, FIG. 4 illustrates a block diagram of a device 400 within which various disclosed embodiments may be implemented. The device 400 comprises at least one processor 404 and/or controller, at least one memory 402 unit that is in communication with the processor 404, and at least one communication unit 406 that enables the exchange of data and information, directly or indirectly, through the communication link 408 with other entities, devices, databases and networks. The communication unit 406 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 400 of FIG. 4 may be integrated as part of a first device, a second device, a database and/or other devices that are described in the present application to carry out some or all of the operations that are described in the present application.

FIG. 5 illustrates a set of exemplary operations that can enhance presentation of a second content in synchronization with a first content in accordance with another exemplary embodiment. At 502, a first portion of a first content is received at a second device from a first device. At 504, the first portion of the first content is receives at the second device from a third device. At 506, the first portion of the first content received from the first device and the first portion of the first content received from the third device are combined to obtain a combined content. At 508, the combined content is processed to obtain a multimedia presentation tracking information. At 510, the multimedia presentation tracking information is used to enable presentation of a second content in synchronization with the first content.

FIG. 6 illustrates a set of exemplary operations that can enhance presentation of a second content in synchronization with a first content in accordance with another exemplary embodiment. At 602, information indicative of a multimedia presentation tracking information from a first content being presented by a first device is received at a second device equipped with a multimedia presentation tracking watermark detector. The received information comprises a source identifier identifying a first source used for obtaining the multimedia presentation tracking information. At 604, a first reliability of the received multimedia presentation tracking information is determined based on at least the source identifier. At 606, the first reliability is compared to a second reliability associated the multimedia presentation tracking watermark detector. At 608, upon a determination that the first reliability exceeds the second reliability, the received multimedia presentation tracking information is selected to enable presentation of a second content in synchronization with the first content.

Another exemplary embodiment relates to a method that includes receiving, at a second device, at least a first portion of a first content being presented by a first device, processing at least the first portion of the first content to obtain a first multimedia presentation tracking information, receiving, at the second device, a second multimedia presentation tracking information associated with the first content from a device other than the second device. The above noted method also includes augmenting the first multimedia presentation tracking information and the second multimedia presentation tracking information to obtain a combined multimedia presentation tracking information, and using the combined multimedia presentation tracking information to enable presentation of a second content in synchronization with the first content.

The components or modules that are described in connection with the disclosed embodiments can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving, at a second device, at least a portion of a first content being presented by a first device, the first content comprising substantially imperceptible watermarks that are embedded in one or more components of the first content;
performing watermark detection operations to obtain a first watermark detection result;
receiving, at the second device, a second watermark detection result associated with the first content from a device other than the second device;
augmenting the first watermark detection result and the second watermark detection result to obtain a combined watermark detection result; and
using the combined detection result to enable presentation of a second content in synchronization with the first content.

2. The method of claim 1, wherein using the combined detection result improves synchronization of the presentation of the second content with respect to the first content compared to a synchronization that would be achieved using the first detection result alone or the second detection result alone.

3. The method of claim 1, wherein the second detection result enables presentation of the second content in synchronization with the first content when at least a part of the first detection result is missing or is unreliable.

4. The method of claim 1, wherein the second watermark detection result is communicated to the second device using a non-acoustical communication channel.

5. The method of claim 4, wherein the non-acoustical communication channel uses one of a WiFi or Bluetooth technologies.

6. The method of claim 1, wherein the second watermark detection result is obtained from processing one or more components of the first content that is obtained using one or more of the following channels:
an acoustical channel;
an non-acoustical channel;
an optical channel; or
a non-optical channel.

7. The method of claim 1, further comprising
receiving, at the second device, a third watermark detection result; and
augmenting the first watermark detection result, with the second and the third watermark detection results to obtain the combined watermark detection result.

8. The method of claim 1, wherein augmenting the first watermark detection result and the second watermark detection result comprises one or more of:
averaging the first watermark detection result and the second watermark detection result on a symbol-by-symbol basis;
averaging the first watermark detection result and the second watermark detection result on a symbol-by-symbol basis based on weights assigned to each symbol;
averaging the first watermark detection result and the second watermark detection result on a packet-by-packet basis; or
averaging the first watermark detection result and the second watermark detection result on a packet-by-packet basis based on weights assigned to each packet.

9. The method of claim 1, further comprising:
communicating one or more of the first, the second or the combined watermark detection results to a device other than the second device.

10. The method of claim 1, wherein the embedded watermarks are multimedia presentation tracking (MPT) watermarks, comprising information that enables one or more of the following:
identification of the first content,
tracking a timeline of the first content,
identification of one or more distribution channels of the first content,
identification of a television channel that the first content is presented on,
determination of a time of broadcast of the first content,
presentation of a foreign language edition of the first content, or
identification of the second content.

11. A device, comprising:
a watermark extractor to produce a first watermark detection result based on embedded watermarks extracted from at least a portion of a first content as the first content is being presented by a first device;
a receiver coupled to a wireless communication channel to receive a second watermark detection result;
a processor configured to augment the first the first watermark detection result and the second watermark detection result to obtain a combined watermark detection result, and to enable presentation of a second content in synchronization with the first content.

12. The device of claim 11, wherein the combined detection result improves synchronization of the presentation of the second content with respect to the first content compared to a synchronization that would be achieved using the first detection result alone or the second detection result alone.

13. The device of claim 11, wherein the second detection result enables presentation of a second content in synchronization with the first content when at least a part of the first detection result is missing or is unreliable.

14. The device of claim 11, wherein the wireless communication channel uses one of a WiFi or Bluetooth technologies.

15. The device of claim 11, wherein:
the receiver is configured to receive a third watermark detection result; and
the processor is configured to augment the first watermark detection result, with the second and third watermark detection results to obtain the combined watermark detection result.

16. The device of claim 11, wherein the processor is configured to augment the first watermark detection result and the second watermark detection result by one or more of:
averaging the first watermark detection result and the second watermark detection result on a symbol-by-symbol basis;
averaging the first watermark detection result and the second watermark detection result on a symbol-by-symbol basis based on weights assigned to each symbol;
averaging the first watermark detection result and the second watermark detection result on a packet-by-packet basis; or
averaging the first watermark detection result and the second watermark detection result on a packet-by-packet basis based on weights assigned to each packet.

17. The device of claim 11, further comprising:
a transmitter coupled to a communication module to communicate one or more of the first, second or combined watermark detection results to a different device.

18. A device, comprising:
a processor; and
a memory comprising processor executable code, the processor executable code, when executed by the processor, configures the device to:
receive at least a portion of a first content being presented by a first device, the first content comprising substantially imperceptible watermarks that are embedded in one or more components of the first content;
perform watermark detection operations to obtain a first watermark detection result;
receive a second watermark detection result associated with the first content from a device other than the second device;
augment the first watermark detection result and the second watermark detection result to obtain a combined watermark detection result; and
use the combined detection result to enable presentation of a second content in synchronization with the first content.

19. A computer program product, embodied on one or more non-transitory computer readable media, comprising:
program code for receiving at least a portion of a first content being presented by a first device, the first content comprising substantially imperceptible watermarks that are embedded in one or more components of the first content;
program code for receiving performing watermark detection operations to obtain a first watermark detection result;
program code for receiving a second watermark detection result associated with the first content from a device other than the second device;
program code for augmenting the first watermark detection result and the second watermark detection result to obtain a combined watermark detection result; and
program code for using the combined detection result to enable presentation of a second content in synchronization with the first content.

20. A system comprising:
a first device coupled to one or both of a display screen or a speaker to present a first content, wherein the first content includes substantially imperceptible watermarks that are embedded in one or more components of the first content; and
a second device comprising:
one or more of a communication module, a microphone, a camera, an audio input or a video input to receive at least a portion of the first content as the first content is being presented by the first device;
a watermark extractor component to perform watermark detection operations to obtain a first watermark detection result from the received portion or portions of the first content;
wherein one or more of the communication module, the microphone, the camera, the audio input or the video input further enabling the second device to receive a second watermark detection result associated with the first content from a device other than the second device; and
a processor coupled to one or more of the communication module, the microphone, the camera, the audio input, the video input, or the watermark extractor component to augment the first watermark detection result and the second watermark detection result to obtain a combined watermark detection result, and to use the combined detection result to enable presentation of a second content in synchronization with the first content.

21. The system of claim 20, further comprising a database that is coupled to at least one of the first device or the second device.

22. The system of claim 21, wherein the second device is configured to receive the second watermark detection results from the database.

23. The system of claim 20, further comprising at least a third device that is coupled to the second device through a communication channel and the third device is configured to produce the second watermark detection result and to communicate the second watermark detection result to the second device.

24. The system of claim 20, wherein the second watermark detection result is obtained from processing one or more components of the first content that is obtained using one or more of the following channels:
an acoustical channel;
an non-acoustical channel;
an optical channel; or
a non-optical channel.

25. A method for enhancing synchronized presentation of a second content with respect to a first content, the method comprising:
producing a first watermark detection result based on processing a particular segment of the first content that is received from one of: an optical channel or an acoustical channel;
receiving a second watermark result through a wireless communication channel that is not an optical or an acoustical channel, the second watermark detection result corresponding to the particular segment of the first content;
augmenting the first watermark detection result and the second watermark detection result to obtain a combined watermark detection result; and
using the combined detection result to enable presentation of the second content in synchronization with the first content.

26. A computer program product, embodied on one or more non-transitory computer readable media, comprising:
program code for producing a first watermark detection result based on processing a particular segment of the first content that is received from one of: an optical channel or an acoustical channel;
program code for receiving a second watermark result through a wireless communication channel that is not an optical or an acoustical channel, the second watermark detection result corresponding to the particular segment of the first content;
program code for augmenting the first watermark detection result and the second watermark detection result to obtain a combined watermark detection result; and
program code for using the combined detection result to enable presentation of the second content in synchronization with the first content.

27. A device, comprising:
a processor; and
a memory comprising processor executable code, the processor executable code, when executed by the processor, configures the device to:
produce a first watermark detection result based on processing a particular segment of the first content that is received from one of: an optical channel or an acoustical channel;
receive a second watermark result through a wireless communication channel that is not an optical or an acoustical channel, the second watermark detection result corresponding to the particular segment of the first content;
augment the first watermark detection result and the second watermark detection result to obtain a combined watermark detection result; and
use the combined detection result to enable presentation of the second content in synchronization with the first content.

28. A method, comprising:
receiving, at a second device from a first device, a first portion of a first content;
receiving, at the second device from a third device, the first portion of the first content;
combining, at the second device, the first portion of the first content received from the first device and the first portion of the first content received from the third device to obtain a combined content;
processing, at the second device, the combined content to obtain a multimedia presentation tracking information; and
using the multimedia presentation tracking information to enable presentation of a second content in synchronization with the first content.

29. A computer program product, embodied on one or more non-transitory computer readable media, comprising:
program code for receiving, at a second device from a first device, a first portion of a first content;
program code for receiving, at the second device from a third device, the first portion of the first content;
program code for combining, at the second device, the first portion of the first content received from the first device and the first portion of the first content received from the third device to obtain a combined content;
program code for processing, at the second device, the combined content to obtain a multimedia presentation tracking information; and
program code for using the multimedia presentation tracking information to enable presentation of a second content in synchronization with the first content.

30. A device, comprising:
a processor; and
a memory comprising processor executable code, the processor executable code, when executed by the processor, configures the device to:
receive, from a first device, a first portion of a first content;
receive, from a third device, the first portion of the first content;
combine the first portion of the first content received from the first device and the first portion of the first content received from the third device to obtain a combined content;
process the combined content to obtain a multimedia presentation tracking information; and
use the multimedia presentation tracking information to enable presentation of a second content in synchronization with the first content.

31. A method, comprising:
receiving, at a second device equipped with a multimedia presentation tracking detector, information indicative of a multimedia presentation tracking information obtained from a first content being presented by a first device, the information comprising a source identifier identifying a first source used for obtaining the multimedia presentation tracking information;
determining a first reliability of the received multimedia presentation tracking information based on at least the source identifier;
comparing the first reliability to a second reliability associated with the multimedia presentation tracking watermark detector; and
upon a determination that the first reliability exceeds the second reliability, selecting the received multimedia presentation tracking information to enable presentation of a second content in synchronization with the first content.

32. A computer program product, embodied on one or more non-transitory computer readable media, comprising:
program code for receiving, at a second device equipped with a multimedia presentation tracking detector, information indicative of a multimedia presentation tracking information obtained from a first content being presented by a first device, the information comprising a source identifier identifying a first source used for obtaining the multimedia presentation tracking information;
program code for determining a first reliability of the received multimedia presentation tracking information based on at least the source identifier;
program code for comparing the first reliability to a second reliability associated with the multimedia presentation tracking watermark detector; and
program code for, upon a determination that the first reliability exceeds the second reliability, selecting the received multimedia presentation tracking information to enable presentation of a second content in synchronization with the first content,
program code for upon a determination that the first reliability exceeds the second reliability, selecting the received multimedia presentation tracking information to enable presentation of a second content in synchronization with the first content.

33. A device, comprising:
a processor; and
a memory comprising processor executable code, the processor executable code, when executed by the processor, configures the device to:
receive information indicative of a multimedia presentation tracking information obtained from a first content being presented by a first device, the information comprising a source identifier identifying a first source used for obtaining the multimedia presentation tracking information;
determine a first reliability of the received multimedia presentation tracking information based on at least the source identifier;
compare the first reliability to a second reliability associated with a multimedia presentation tracking watermark detector of the device; and
upon a determination that the first reliability exceeds the second reliability, select the received multimedia presentation tracking information to enable presentation of a second content in synchronization with the first content.
